(19) United States
(12) Patent Application Publication
(10) Pub. No.: US 2006/0003653 A1
(43) Pub. Date: Jan. 5, 2006

(54) Synthetic fabric which mimics a dried grass fabric

(75) Inventors: Carroll Brown Hart SR., Greenville, SC (US); Jay Reiss Long II, Anderson, SC (US); Gregory Lynn Vaughn, Donalds, SC (US); James Russell Davis, Honea Path, SC (US)

Correspondence Address: DORITY & MANNING, P.A., POST OFFICE BOX 1449, GREENVILLE, SC, 29602-1449, US

(73) Assignee: Belton Industries, Inc.

(21) Appl. No.: 10/884,809

(22) Filed: Jul. 2, 2004

(51) Int. Cl. B32B 5/02; B32B 27/04; D03D 15/00; B32B 27/12

(52) U.S. Cl. 442/104; 442/208; 139/420 R; 139/426 TW; 442/149; 442/268

(57) ABSTRACT

A fabric made from yarns that, when woven, mimic straw or other dried grass fabrics. The fabric has a set of polyolefin slit film warp yarns and at least two sets of polyolefin slit film weft yarns interlocking with the set of slit film warp yarns in the form of a weave. At least one of the sets of slit film warp yarns or slit film weft yarns being fibrillated to form ridges in the woven yarns that create a fabric that has a texture of a dried grass fabric having a substantially smooth face. Further, the sets of slit film weft yarns may be woven with the set of slit film warp yarns, so that the fabric has a variability due to varying light reflectivity, coloring and exposure of the sets of slit film warp yarns and slit film weft yarns within the fabric that creates an overall appearance that is a manifestation of a dried grass fabric.

### TECHNICAL FIELD OF THE INVENTION

The present invention relates generally to a fabric woven from synthetic slit film yarns and having the appearance of a fabric woven from strands of straw or dried grass. More particularly, the invention relates to the fabric woven from polyolefin such as polypropylene or polyethylene which mimicks a straw or dried grass fabric for use as a decorative fabric for wall coverings, home furnishings, upholstery, handbags, etc.

### BACKGROUND OF THE INVENTION

Straw or dried grass fabrics or cloths have been used as decorative fabrics in wall hangings, hats, table dressings, handbags, etc., for years. As defined herein, dried grass fabrics include straw fabrics, sisal fabrics, and fabrics made from a dried grass that does not create a fabric having a hairy appearance, like burlap. Rather, dried grass fabrics as used herein have a substantially smooth surface as compared to hairy fabrics made from jute or hemp. Such fabrics have an aesthetically pleasing appearance with their varied colorations and textures. In the past, these fabrics have been in high demand especially for use as wall covering. The dried grass fabrics used as wall covering extends over a wide range of uses for different rooms, from more formal dining rooms to more casual dens or family rooms. Also, such wall coverings can be used in business or commercial settings. Further, these fabric wall coverings are gender neutral so that they appease both feminine and masculine tastes.

In the past few years, such straw or dried grass fabrics have fallen out of favor in some areas of the commercial or residential markets. The fabrics can be hard to manufacture due to the complexity of working with the materials used to weave the fabrics such as straw strands, or other dried grass fibers. Further, at least partially due to the complexity of weaving the fabric as well as other considerations, these wall coverings are usually expensive.

These grass fabrics also tend to mildew easily due to the fact that they are made from natural products like straw or other dried grass. For the same reasons, the fabrics tend to degrade and decay quicker than other fabrics used as wall coverings. Further, these fabrics can be hard to clean if something has been spilled on them or they have become dirty due to their normal use. Once the fabric has been stained, it is nearly impossible to remove such a stain-therefrom.

Therefore, a need exists for a substitute fabric which can mimic the appearance of straw or dried grass fabrics that is easy to manufacture, inexpensive, resists mildew and decay, and can be easily cleaned. Such a fabric can be beneficial in both the commercial and residential market for wall coverings as well as for uses in upholstery(including office modular panels), home furnishings, floor coverings, blinds, table dressings, handbags, and other decorative fabric uses.

### SUMMARY OF THE INVENTION

The present subject matter recognizes and addresses the above briefly discussed drawbacks, and others of the above-described dried grass fabrics. Accordingly, a general aspect of the present subject matter is to provide a synthetic fabric that is inexpensive and easy to manufacture. Further, the fabric should be durable and easy to clean. Additional aspects and advantages of the invention will be set forth in part in the following description, or may be obvious from the description, or may be learned through practice of the invention.

In an exemplary embodiment, a fabric is made from yarns that when woven together mimic straw. A set of polyolefin slit film warp yarns and at least two sets of polyolefin slit film weft yarns are woven together. At least one of the sets of slit film warp yarns or slit film weft yarns have been fibrillated in a manner that the yarns have a texture, which appears as ridges when woven into the fabric. Even though the fibrillated slit film yarns have cuts in the yarns that penetrate through the yarns, when woven into the fabric, ridges are formed in the yarns on the face of the fabric. These ridges in the woven yarn create a visual texture in the yarn and fabric similar to that of dried grass fabrics with a substantially smooth face or surface. A serration process can also be used to form ridges in the woven yarns as well.

In another exemplary embodiment, the fabric includes at least one set of polyolefin slit film warp yarns that have been colored a certain specified color. At least two sets of polyolefin slit film weft yarns interlock with the warp yarns to form the weave of the fabric. Each of the sets of weft yarns are colored a different color so that one of the sets of weft yarns is darker in at least one of shade or color than the other set of weft yarns. At least one of the sets of warp yarns or weft yarns are serrated and the other sets of warp yarns or weft yarns are fibrillated to form ridges in the woven yarns without creating a hairy appearance in the fabric. The two sets of weft yarns are woven with the set of warp yarns in a manner so that the fabric has a random variability due to light reflectivity, coloring, and exposure of the sets of warp and weft yarns within the fabric. This variability in the fabric creates a uniform overall appearance that is a manifestation of a straw or dried grass fabric.

The weft yarns may be twisted during their insertion into a shed during the formation of the fabric. In some embodiments, each of the at least two sets of yarns may be twisted in a different direction respectively, so that one of the weft yarns has a slight “Z”-twist while the other weft yarn has a slight “S” twist. In other embodiments, the twists may be in all one direction such as an “S”-twist.

In some exemplary embodiments, at least one of the sets of warp yarns or weft yarns is delustered. The yarns may be delustered mechanically or chemically. The delustering process, which consists of roughing up the surface of the yarns in order to remove the shiny appearance of the polyolefin slit film yarns, can aid in creating a fabric with the appearance of straw or other dried grass. The delustering process aids the serration and fibrillation of the slit film warp and weft yarns in creating that look of a dried grass fabric.

The slit film yarns can be woven together in many different styles. The weave may be one of a basket weave, a twill, a plain weave, a sateen, a broken twill, a herringbone, etc. Further, the construction of these weaves may vary as well. For example, the basket weave may be a 2×4 basket weave or a 2×2 basket weave. Another example would be the construction of a broken twill weave such as a 2×2 broken twill weave or a 3×1 broken twill (“crowfoot”) weave.

The polyolefin slit film yarns may be a polypropylene, a polyethylene, a high density polyethylene, or the like. Such materials are inexpensive as well as durable. They are resistant to mildew and decay as compared to fabrics made of natural straw or dried grass. A further benefit of using such materials is that the polyolefin can be mixed with certain additives to create desired properties in the yarn and thereby the fabrics. For example, the polyolefin material may be mixed with a fire retardant additive to slow down or stop a potential burning of the fabric. Further, in places where a clean environment is needed, anti-bacterial additives may be included in the polyolefin to help sterilize the surface of the fabric. Such fabrics may be useful as wall coverings and/or upholstery for furniture in hospitals. Fabrics made from such material are also easy to clean. Dirt can be removed easily from fabrics made of such material without leaving any marks or stains. Further, certain additives, which can change the coloration of the fabric such as a metallic additive that may make a yarn appear to be metallic in color, may be added to the polyolefin material to create variation in the appearance of the fabric to add variety.

A backing may be applied to the fabric to stiffen it and/or to prevent zippering or unraveling of the fabric. Such a backing can make the fabric more conducive to be used as a wall covering or an upholstery fabric.

In another embodiment, the fabric can include a set of a polyolefin slit film warp yarn, at least one set of a polyolefin slit film weft yarn, and at least one set of a second weft yarn that is not a slit film yarn. In this embodiment, it may be preferable to have the slit film weft yarns colored a different shade than the polyolefin slit film warp yarns. In this embodiment, at least one of the sets of polyolefin slit film warp yarns or weft yarns may be serrated and the other set of polyolefin slit film warp yarns or weft yarns may be fibrillated to form ridges in the woven yarn without creating a hairy appearance in the yarn or the fabric. By preventing the yarns and thereby the fabric from having a hairy appearance, the fabric is prevented from the having the appearance of a jute or burlap fabric. The polyolefin slit film warp yarns or weft yarns and a set of second weft yarns are woven together to create a fabric which has a uniform overall appearance as created through variabilities within the fabric, thereby giving the fabric a general appearance of a straw or dried grass fabric with a second yarn woven therein.

In such a fabric, the variability within the fabric can be at least partially attributed to the varying light reflectivity due to the processing the slit film weft yarns and warp yarns. Further, such variability may also be at least partially attributable to the different colors of shading of the set of polyolefin slit film warp yarns and the set of polyolefin slit film weft yarns as well as the set of second weft yarns.

The second set of weft yarns used in such an embodiment may be a BCF yarn or a chenille yarn, or some other type of yarn that is not necessarily a slit film yarn. In most embodiments, the second set of weft yarns will be bulky yarns. These types of yarns help with the cover factor of the fabric and also add to the variation of the fabric that creates an overall uniform appearance.

Again, this fabric may have a backing applied to the fabric to make the fabric more conducive as wall covering, upholstery, or some other end use that requires the fabric to be more durable. The backing may also be used as described in other embodiments to prevent zippering or unraveling of the fabric.

Other features of the present subject matter will be described in greater detail through the use of the appended figures.

### BRIEF DESCRIPTION OF THE DRAWINGS

FIG. 1 shows a perspective view of an embodiment of a fabric according to the present invention;

FIG. 2 shows a perspective diagrammatical view of a fabric according to the present invention which illustrates the twist of the weft yarns disposed therein;

FIG. 3 shows a perspective view of a further embodiment of a fabric according to the present invention;

FIG. 4 shows a perspective view of an embodiment of a fabric woven from slit film yarns and a second bulky yarn used in the weft direction according to the present invention;

FIG. 5 shows a process of adding a backing to a woven fabric according to the present invention;

FIG. 6 shows a flow chart for the process of making the warp yarns for the fabric shown in FIG. 1;

FIG. 7 shows a process for the manufacturing of the first weft yarns used in the fabric illustrated in FIG. 1;

FIG. 8 shows a flow chart for the manufacturing of the second slit film weft yarn used in the fabric illustrated in FIG. 1;

FIG. 9 shows the process is beaming, weaving, and if necessary, finishing the fabric illustrated in FIG. 1.

### DETAILED DESCRIPTION

Reference will now be made in detail to the presently preferred embodiments of the invention, one or more examples of which are shown in the figures. Each example is provided to explain the invention, and not meant as a limitation of the invention. In fact, features illustrated or described as part of one embodiment can be used with another embodiment to yield still a third embodiment. It is intended that the present invention cover such modifications and variations.

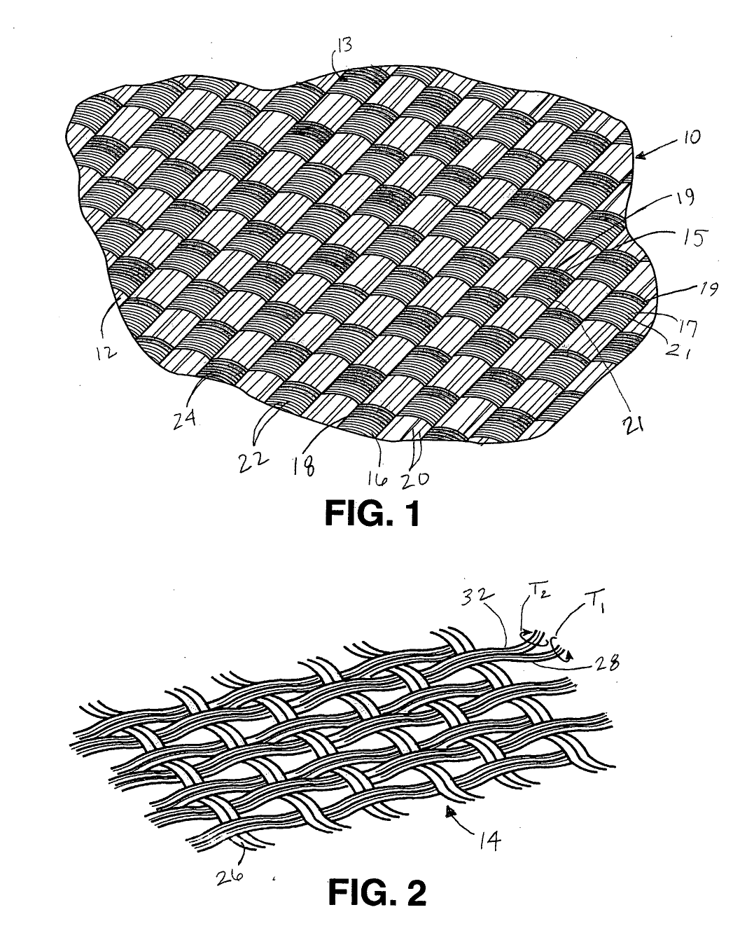

FIG. 1 shows a fabric, generally 10, woven from synthetic slit film yarns, also known as tape yarns, ribbons or flat yarns. Slit film yarns have a flat appearance with widths being much larger than their thicknesses. The fabric 10 has the appearance of a fabric constructed of straw or dried grass even though synthetic slit film yarns are used to weave the fabric. The fabric 10 looks like a straw fabric due to the characteristics of the yarns used to weave the fabric as well as the construction of the fabric. The fabric 10 illustrates a 2×2 basket weave with slit film warp yarns 12 running in a longitudinal direction and two sets of slit film weft yarns 16, 18 running in a latitudinal direction. The warp yarns 12 and the weft yarns 16, 18 have ridges 20, 22, 24 respectively disposed therein. These ridges 20, 22, 24 are formed by running the yarns 12, 16, 18 through a serration or a fibrillation process which will be explained in further detail below. In the exemplary embodiment of fabric 10, the slit film warp yarn 12 is, for example, a serrated light color beige slit film yarn, while slit film weft yarn 16 is a fibrillated medium color beige slit film yarn and slit film weft yarn 18 is a fibrillated dark color beige slit film yarn.

The ridges 20, 22, 24 formed in the warp yarns 12 and the weft yarns 16, 18 create a visual texture in the yarns 12, 16, 18 and fabric 10 that mimics that of a texture of a straw or other dried grass fabric. Texture as used herein refers to visual texture and appearance of the yarn and fabric, although the fabric may also have a similar tactile texture as a dried grass fabric. These ridges 20, 22, 24 help the fabric have a substantially smooth, non-hairy appearance, while creating that desired texture within the yarns and the fabrics. “Substantially smooth” is defined herein as being mostly smooth with few fiber or fibril strands extending from the surface of the fabric so as not to give a hairy appearance to the fabric, like a burlap fabric. The processing of the yarns 12, 16, 18 and the weaving of the fabric 10 help to create the desired visual texture that gives the fabric 10 the manifestation of a dried grass fabric by forming the ridges in the yarns.

The appearance of the fabric 10 can also be aided by an instituted variability woven into the fabric 10. The ridges formed in the warp yarns 12 and the weft yarns 16, 18, the color of each of the yarns 12, 16, 18, as well the amount of exposure of each of the yarns on the face of the fabric, especially the weft yarns within the fabric, create a variability in the appearance of the fabric. In a typical fabric in which the aesthetic appearance of the fabric factors into its usability, such variability or non-uniformity would be considered a liability. However, in the construction of the fabric 10, such variability caused by the ridges, color, and exposure of the yarns 12, 16, 18 create random non-uniformity that creates an overall uniform look in the fabric that gives the appearance of a fabric woven of straw, reed, or some other dried grass. In particular, the ridges 20, 22, 24 formed in the yarns 12, 16, 18 create a non-uniformed texture to the fabric and creates variability in the reflectivity of the yarns and the fabric that mimics the texture and reflectivity of straw or dried grass.

Preferably, the synthetic yarns are a polyolefin yarn or the like. In particular, the yarns 12, 16, 18 may be manufactured of a polyolefin such as polypropylene or polyethylene. The polyethylene may be a high-density polyethylene. Such materials are inexpensive, but durable. The materials have the added benefit of allowing additives to be mixed therein. The additives can help control the color of the yarns, and give the yarns other desired properties. For example, a fire retardant additive may be added to the polyolefin material to retard burning of the fabric in case of a fire. Another example would be the addition of an anti-bacterial, anti-microbial, or anti-mildew additive to the polyolefin to prevent germ and bacteria build up on the surface of the fabric. Further, a UV stabilization additive may be blended into the polyolefin resin to help prevent deterioration of the polyolefin due to exposure to sunlight.

Further, polyolefin yarns have the added benefits of their easy care. The fabric may be easily cleaned by soap and water. The nature of polyolefin does not permit fabric woven from such material to absorb stains like fabric woven from natural fibrous material. Dirt can be wiped off a polyolefin fabric with a damp cloth without worrying about the absorption of the dirt and moisture by the fabric. The ease of care as compared to natural fibers creates a definite advantage for the use of polyolefin yarns.

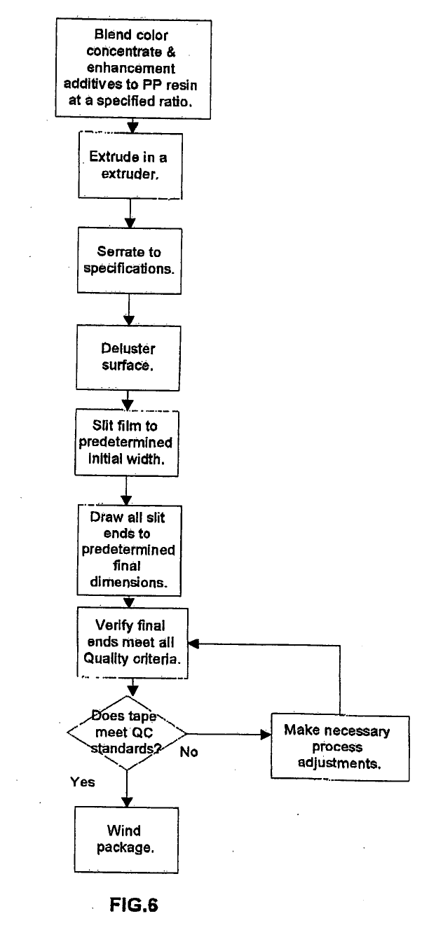

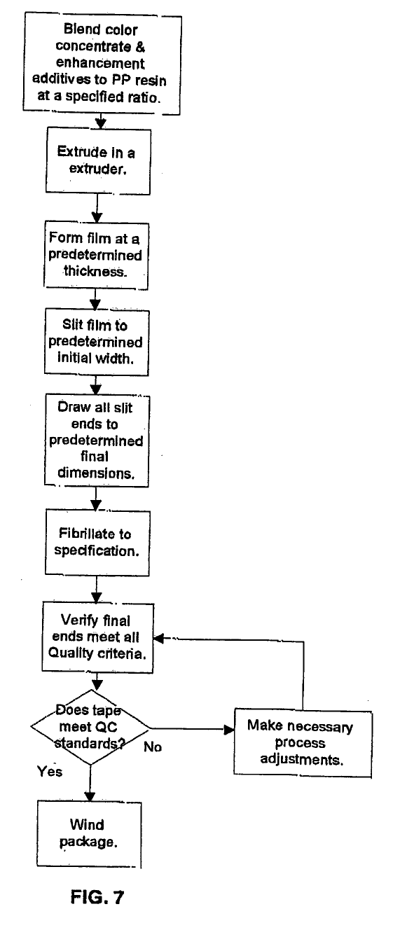

FIG. 6 through 9 illustrate the processes used in the formation of the exemplary yarns 12, 16, and 18 and the exemplary fabric 10. FIG. 6 illustrates the formation of a slit film warp yarn 12. In this example, a color concentrate is mixed with a polypropylene resin to produce the desired colors such as the light color beige of the slit film yarn 12. Other additives may be incorporated at this point in with the polypropylene to create desired qualities in the yarn 12. The mixture of resin and color concentrate is then extruded through an extruder to form a web, or film that is serrated during an extrusion process.

Serration is the forming of deep grooves within the web, or film, that do not penetrate the web. The resulting yarn often splits along the serration at various points during processing of the yarns. These serrations in the resulting yarn, as well as any splitting that occurs, creates for example, the ridges in the warp yarns that give the yarns their desired textures without creating a hairy yarn. The serration is preformed by serrating teeth at the lip of the extruder contacting the web as the web is run across the teeth. The serrating teeth form the deep grooves in the web, but do not cut through the web. The serrating teeth in one exemplary embodiment may be 0.020 inches apart. After being extruded and serrated, the still hot web is then quelched in a water bath before having both surfaces of the web delustered in a delustering process, using sandpaper covered rolls or some other known delustering apparatus to roughen the faces of the web.

The web, or film, is then slit to the predetermined initial width to form the initial slit film yarns. The slit film yarns are then drawn to their predetermined final dimensions. Normally, the warp yarns can have a denier between 500 to 3500 and preferably between 1500 and 2700 denier, while having a thickness between 1 and 3 mils and a width between 50 and 250 mils.

The quality of the slit film yarns is verified against specified quality criteria such as dimensional and color checks. If the slit film yarns meet the quality control standards, the ends (or yarns) are then wound onto packages on a winder.

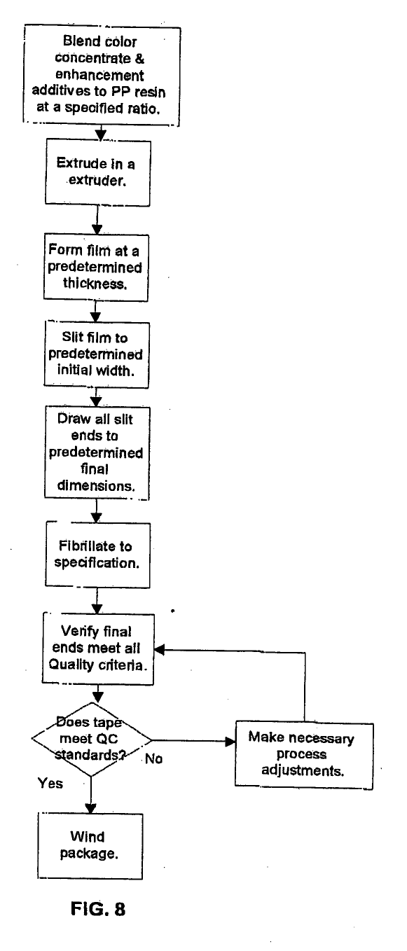

FIG. 7 and 8 show a similar process for the formation of the slit film weft yarns 16 and 18. The major difference in this embodiment between the process for the warp yarns and the process for the weft yarns is that, instead of serrating the yarn as done with the warp yarns, the weft yarns are fibrillated. Fibrillation is the cutting or tearing of the yarn into interconnected fibrils. Different processes form different fibrillated yarn appearances. The set-up for fibrillation of a slit film yarn can depend on the qualities and characteristics of the desired end use yarn. Certain fibrillation processes and the amount of fibrillation that occurs may cause the yarn to appear hairy due to the amount and type of breaks or cuts in the slit film yarn. By changing the amount of fibrillation and/or the set up or type of fibrillation process, the yarns may have a less hairy appearance and more of a substantially smooth appearance and texture of a dried grass or piece of straw.

Referring to FIG. 7, the process of forming the slit film yarn 16 is described. A color concentrate such as the medium color beige is mixed with the polypropylene resin which is then extruded from an extruder to form a flat web or film of a predetermined initial thickness. The web is then slit to a predetermined initial width of the slit film weft yarn 16. The weft yarns 16 are then drawn to the predetermined final dimensions of the yarn. In some embodiments, the weft yarn 16 may have a denier ranging between 500 to 3500 denier. The thickness may range between 1 and 4 mils, and the width of the weft yarn 16 may range between 50 and 300 mils depending on the desired specification of the yarn.

The slit film weft yarns 16 are then fibrillated to specification by running the yarns over a series of rotating collars having spaced cutting edges extending therefrom. The spaced edges on the collar cut through the slit film yarn 16. Since the collars are rotating, the spaced edges do not continuously cut along the same line due to the spacing between the cutting edges. This spacing of the cuts allows the yarn to have an internal structure which keeps the newly formed fibrils attached to one another. The fibrillation process should be set up to allow the slit film yarns to be fibrillated to the point that they have the appearance or texture of a strand of straw or dried grass but not to the point where they obtain the look of a hairy yarn. This substantially smooth appearance of the yarns and fabric separate them from looking like a jute yarn or a burlap fabric.

Once the slit film weft yarns 16 has been fibrillated, the quality of the yarns 16 are verified and if the yarns 16 meet the quality control standards, the yarns 16 are then wound onto packages.

The slit film weft yarns 18 are processed in a similar manner to the weft yarns 16. A polypropylene resin is blended with a color concentrate to create a dark colored beige for the slit film weft yarns 18. As with weft yarns 16, other additives can be incorporated into the polypropylene resin at this point. The blended polypropylene resin is then extruded to form a flat web or film at a predetermined thickness. The web is then slit to a predetermined initial width of the weft yarns 18. The weft yarns are then drawn to their predetermined final dimensions. The weft yarns 18 are then fibrillated to specification in the same manner as the weft yarns 16. The quality control standards are verified for the yarns 18, and the yarns 18 are then placed on packages by winders.

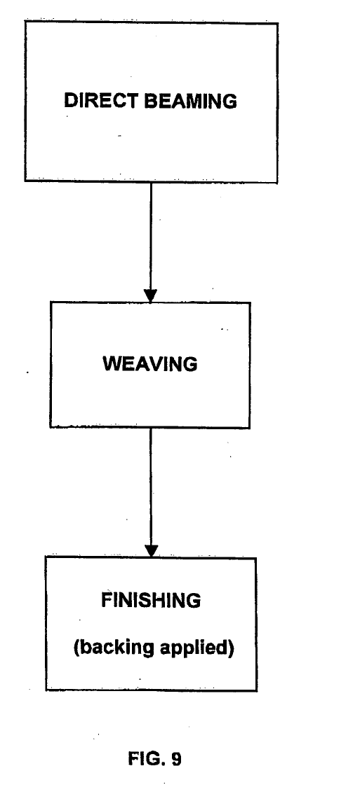

For the weaving process, the warp yarns 12 need to be removed from the packages and placed on a warp beam while the weft yarns 16, 18 can be processed from their packages in the weaving process. FIG. 9 generally shows the next steps in the formation of the fabric and, if desired, the formation of the product which can be used as a wall covering. The packages of warp yarns are placed into a creel and the ends (yarns) are then warped onto a warp beam. Unlike warping of traditional yarns, this beaming can be a direct beaming process, meaning that the warp beam created from the packages of yarns goes directly to weaving. In warping of traditional yarns, the yarns from the packages are beamed onto a warp beam and then taken to a slasher to add sizing to the yarns. The yarns are then rebeamed with yarns from other beams to form the large warp beam used in the weaving process. The slit-film polyolefin warp yarns do not require a slashing process. Sizing does not need to be added to strengthen the yarn for the abusive weaving process. Therefore, the slit-film warp yarns can be beamed directly to the warp beam used in weaving.

Due to the number of packages needed to fill the warp beam and thus the creel, a system can be used to randomize the packages to minimize the effect of any variations between the characteristics on the warp yarns on the packages themselves. However, such a system is not necessary, especially if the coloring of the warp yarns 12 is consistent enough among different batches. Once the warp yarns 12 are creeled, they are beamed onto the warp beam in a known manner. The number of ends warped onto the beam can vary depending on the width of the fabric and the fabric construction. In one embodiment, about 3,000 ends are warped onto a beam.

Once the warp beam is filled with the warp yarns 12, the beam is taken into the weaving area where the beam will be tied into a weaving machine. Once the warp ends are tied in, the weaving process can start.

The warp ends are controlled by a set of harness frames, or harnesses, contained within the weaving machine or loom. The harnesses are used to form sheds in which the weft yarns 16, 18 are inserted. After each filling insertion, the harnesses change positions to form a new shed and a reed is used to beat up the fabric to ensure the tightness of the weave in the fabric. The weaving process may be performed on any of the suitable conventional weaving processes depending on the type of weaving machine or loom that is used. For example, airjet weaving machines (under certain circumstances), water jet weaving machines, projectile looms, rapier looms, Jacquard loom, etc., may be used to weave the fabric. A package each of the first weft yarn 16 and the second weft yarn 18 supply each yarn 16, 18, respectively, for the filling insertion.

For the fabric 10 shown in FIG. 1, one pick of each of the weft yarns 16, 18 is inserted in each shed formation. In some embodiments, it may be advantageous to insert a slight twist in the weft yarns 16, 18 which may help in the formation and the pronouncement the ridges in the weft yarns in the woven fabric. Such slight twists may also aid in the variability in the light reflectivity of the fabric. The twists of the weft yarns 16 and 18 may be held at a constant turns per inch by wrapping the weft yarn 16, 18 around a cylindrical body called an accumulator and then pulling the weft yarns 16, 18 off of the cylindrical body during the insertion of the weft yarn 16, 18 into the shed formation. The amount of twists may be varied by the size of the diameter of the accumulator.

The twists may also be varied between the weft yarns 16, 18 within the fabric. Such variation in twist may be by just pulling the yarn off of the package. As the size of the package changes, the amount of twist inserted into the weft yarns 16 and 18 will vary among the picks.

In some embodiments, the direction of the twist may vary among the weft yarns within the fabric. For example, as in FIG. 2, a diagram of a fabric 14 is shown in a loose weave for illustration purposes to demonstrate the different twists of a weft yarn 28 and a weft yarn 32. Fabric 14 is a two by two weave with two slit film warp yarns 26 per end formation and two slit-film weft yarns 28, 32 per pick formation. As shown in FIG. 2, weft yarns 32 may be inserted into the fabric with an “S”-twist T₂ while weft yarns 38 are inserted with a “Z”-twist T₁. This difference in twist between the weft yarns can create a further variability in both the pronouncement of the ridges formed as well as the light reflectivity of the fabric.

As noted above, if twist is inserted into the weft yarns 16, 18, the twist may be in only a “Z”-twist in some embodiments. In other embodiments, the twist in the weft yarns 16, 18 may be in only an “S”-twist.

Another factor, which aids in the variability within the fabric to create an overall uniform look, is the amount of exposure each of the yarns 12, 16, 18 have on the face 11 of the fabric 10. The face position of the weft yarns demonstrates the varying exposure. A face position is defined as an area of exposure of yarns running in one direction on the face of a fabric between yarns running in the perpendicular direction on the face of the fabric. As can be seen by the face positions 13 of the weft yarns 16, 18, the amount of exposure of each weft yarn 16 and 18 in each face position 13 varies from face position to face position. For example, face position 15 and a face position 17 are both formed by the same two specific slit film weft yarns 19 and 21. However, in face position 15 more of the second slit film weft yarn 19 which is a darker colored beige is exposed in the face position then the medium color beige first slit film weft yarn 21. On the other hand, in face position 17, more of the first slit film weft yarn 21 is exposed as compared to the second slit film weft yarn 19.

Due to the color variation between the two yarns, you can distinctly see variations between the different face positions 13 of the face 11 of the fabric 10. This variation in exposure of the different weft yarns 16, 18, 19, 21 is created at least in part by the fibrillation or serration preformed on the slit film yarns as well as the twists that may be inserted into the yarn. Further, the beat up of the fabric during the weaving and the tightness of the weave also help to create such variation. This variation in color of the face 11 of the fabric 10 can further help to make this synthetic fabric mimic a straw or dried grass fabric. Inserting a different direction twist for each weft yarn inserted within a shed formation may also help to add to the variation and exposure to each weft yarn on the face 11 of the fabric 10.

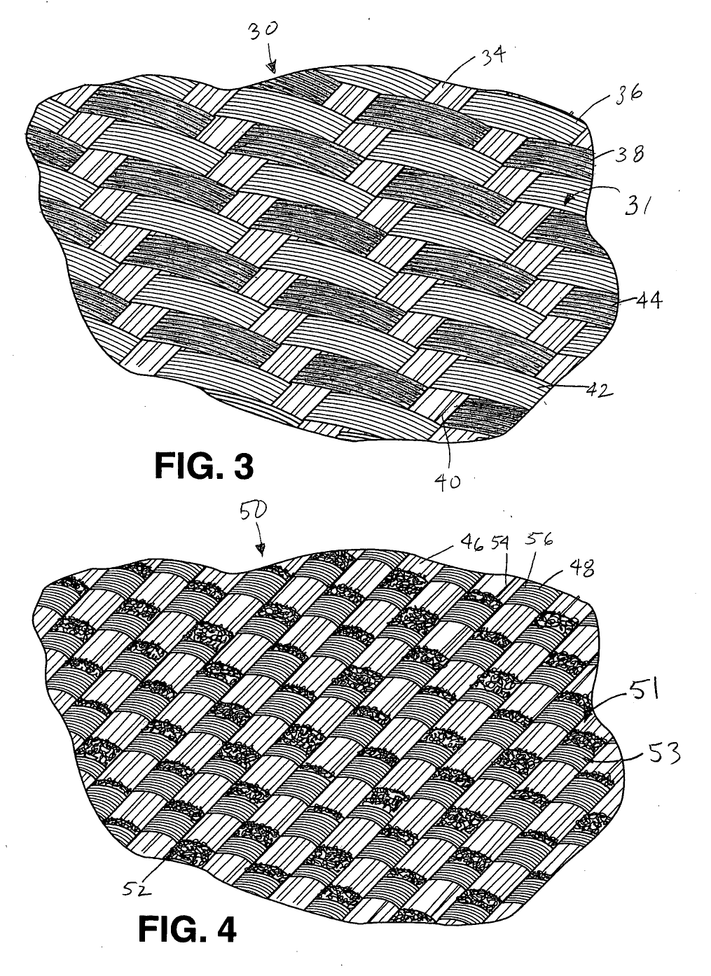

The explanation provided for the formation of the weave using the 2×2 basket weave is done by way of explanation only and is not meant as a limitation. Other weave formations may be used such as a twill, a plain weave, a satin, a broken twill, a herringbone, etc. For example, FIG. 3 shows a fabric, generally 30, constructed of a broken twill weave. Slit film warp yarns 30 run along the fabric in a longitudinal direction while first slit film weft yarn 36 and second slit film weft yarn 38 run in a latitudinal direction. In this embodiment, warp yarn 34 is colored a lighter color than medium colored first weft yarn 36 and darker colored second weft yarn 38.

Ridges 40 formed in the warp yarns 34 and the ridges 42, 44 formed in the weft yarns 36, 38, respectively, may be created in a similar manner as described with the fabric 10 in FIG. 1 and in the process described in FIGS. 6-8 by either serration or fibrillation of the yarns 34,36,38. The ridges 40,42, 44 in the yarns 34,36,38 give the yarns and the fabric a texture of a straw or dried grass fabric. Due to the process of the serration as well as the way the fibrillation is performed, the fabric is not hairy or fuzzy like a jute fabric or a jute substitute would be. Instead, the fabric has a substantially smooth surface on its face or surface. These ridges and substantially smooth face or surface of the fabric are because the fibrillation and the serration formed on the slit film yarns 34, 36, and 38 do not break the fibrils or the strands from the body of the slit film yarn to an extent that causes the yarn to be excessively hairy. Therefore, the fabric does not possess that hairy or fuzzy appearance of jute or burlap, but more aptly mimics the substantial smoothness of a straw or other dry grass fabric. As stated earlier, “substantially smooth” as with other described embodiments means that the fabric may have a few “hairy” fibers or fibrils extending from the surface or face of the fabric, or even have a “micro-hairiness” that is not readily visually perceptible without close observation, but the fabric has an overall smooth appearance as compared to a jute fabric such as burlap.

As with fabric 10 in FIG. 1, fabric 30 creates a variability in a fabric due to the ridges, light reflectivity, color and exposures of the yarn 34, 36, 38 that further helps to mimic a straw or other dried grass fabric. The manner of exposure of each yarn 34, 36, and 38 may vary on the face 31 of the fabric 30. The amount of exposure of the yarns can be affected by the processing of the yarn such as the serration, fibrillation, or twist added therein or even by the weaving process. Again, such variation of exposure of each yarn 34, 36, and 38 creates added variability in the fabric, which helps to create a uniform overall look.

In some embodiments, it may be beneficial to have at least two of the yarns colored different colors from each other. In this manner the added variability of the different colors within the fabrics add to the non-uniformity of the fabric, which creates an overall uniform look in the fabric. These colors can be different from each other on the spectral range of colors, or as has been explained in regards to fabric 10 and 30 the colors may be different shades of a base color. Having different colored sets of yarn that are not necessarily the same natural color as a grass fabric or a straw fabric do not take away from its appearance as a fabric which mimics a straw or dried grass fabric. This is due to the texture and appearance caused by the ridges in the yarns within the fabric which give the illusion that they are a natural straw or dried grass fabric. By having different colored yarns within the fabric, the fabric gives the appearance of straw or dried grass strands that have been colored a certain color, instead of the natural color which such strands normally possess in its natural state. The variability in the shades and colors of the yarns, however, increase the look of a fabric woven from natural straw strands or grass fibers.

In the embodiments described thus far, three sets of yarns have been used in each fabric 10, 30. In other embodiments, four or more sets of slit film yarns may be used in the production of the straw-like fabric. In other examples, a fourth yarn may be added which is not a slit film yarn to the fabric during production to add an aesthetically pleasing variation to the fabric while still permitting the fabric to give the appearance of a fabric woven from straw or other type of dried grass. In a still further embodiment, instead of having three slit film yarns to form the fabric, two slit film yarns may be woven together with a third yarn which is not a slit film yarn. FIG. 4 illustrates a fabric 50 constructed of a slit film warp yarn 46 and a slit film weft yarn 48 being woven together with a second weft yarn 52. The second weft yarn 52 may be a bulky yarn such as a BCF yarn or a chenille yarn, which also has a bulky appearance. Further, a conventionally spun yarn may also be used as the second weft yarn 52.

The slit-film warp yarn 46 and the slit film weft yarns 48 possess ridges 54 and ridges 56, respectfully. These ridges 54, 56 can be formed in the yarns 46, 48 through fibrillation or serration as described above. Further, warp yarns 46 and slit film weft yarn 48 may be colored different colors such as a light tan for warp yarn 46 and a medium tan for slit film weft yarn 48. In the embodiment shown in FIG. 4, a 2×1 weave is presented, wherein one warp yarn 46 is presented in each end formation and two weft yarns, slit film weft yarn 48 and second weft yarn 52, are presented in a pick formation. As described above, the face 51 of the fabric 50 creates a variability in the fabric due to the amount of exposure of each of the yarns 46, 48 and 52. Each face position 53 of the weft yarns 48, 52 shows the variability of exposure between the bulky second weft yarn 52 and the slit film weft yarn 48. This variability of exposure helps to create the non-uniformity in the fabric which creates an overall uniform look. As has been found even in such cases where only two slit film yarns are used along with a third non-slit film yarn, especially bulky yarns, the appearance of the fabric as described herein with the ridges and color variations of the two slit film yarns creates an appearance that mimics a straw or dry grass fabric having a second yarn mixed therein.

After the fabric is woven it may be used as is or, for certain applications such as wall coverings or for certain upholstery uses, a backing should be applied to the fabric. As shown in FIG. 9, after the fabric is woven it may be processed in a finishing process. The finishing process consists of applying a backing to the woven fabric to prevent zippering of the fabric or raveling of the fabric. Such a backing may also help the fabric to adhere to a substrate or surface to which it may be applied. Any suitable conventional method of applying a backing to a polyolefin fabric may be used. For example, a known method for applying a backing to the fabric may be the use of applying an acrylic to the back of the woven polyolefin fabric. A paper backing, adhered to the fabric in a suitable conventional manner, may also be used as a backing for the polyolefin fabric.

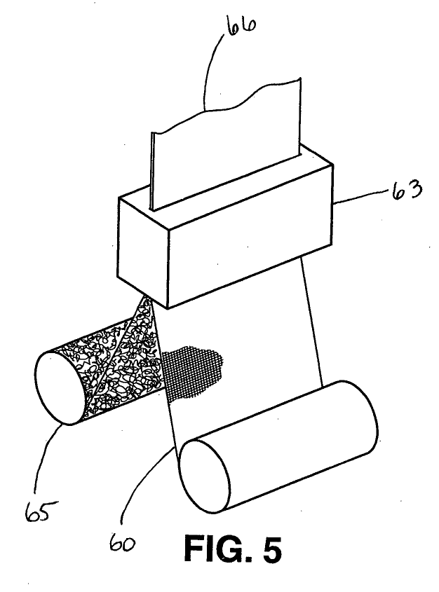

Further, a non-woven may be laminated to the back of the fabric as is shown in FIG. 5. Any suitable conventional process for laminating a nonwoven to a polyolefin fabric may be used. Typically, the nonwoven should have good adhesion properties to allow it to adhere to the substrate or surface to which the laminated fabric will be applied. Fabric 60 can be combined with a nonwoven 65, such as a polypropylene nonwoven, in a laminating process 63 to form a laminated woven product 66 in a known lamination method. For example, the laminating process may be a known point bonding or thermal bonding process where a polypropylene nonwoven is attached to the fabric through the use a suitable adhesive or binder. The nonwoven can be point bonded to the fabric using adhesive or binders known in the art that effectively attaches the chosen nonwoven with the polyolefin fabric to create the laminated fabric product 66. An example of an adhesive or binder to bind a polypropylene nonwoven to a fabric as described above is a polypropylene web adhesive or a polypropylene film. Other suitable resins may also be used.

The backing on the laminated fabric product 66 allows the fabric to be hung as a wall covering more easily. Further, it also allows the laminated fabric product 66 to be used as upholstery in certain settings where the fabric itself may not be conducive for such use. The fabric may be used in other settings to replace straw or dried grass fabric where the user is looking for a fabric which has the overall general appearance of a straw or dried grass fabric but is looking for improved characteristics, stability and wear. As mentioned earlier, other fabric backing applications used in connection with polyolefin yarns may be used to attach a backing to the fabric described above to make the fabric more useful in different settings.

It will be appreciated by those skilled in the art that various modifications and variations can be made in the present invention without departing from the scope and spirit of the invention. It is intended that the present invention includes such modifications and variations as come within the scope of the appended claims and their equivalents.

What is claimed:

1. A fabric made from yarns that, when woven, mimic dried grass, said fabric comprising:
a set of polyolefin slit film warp yarns;
at least two sets of polyolefin slit film weft yarns interlocking with said set of slit film warp yarns in the form of a weave; and
at least one of said sets of slit film warp yarns or slit film weft yarns being fibrillated to form ridges in the woven yarns that create a fabric that has a texture of a dried grass fabric having a substantially smooth face.

2. A fabric as in claim 1, wherein said slit film weft yarns are twisted.

3. A fabric as in claim 2, wherein one of said at least two sets of slit film weft yarns has a different orientation of twist relevant to the other of said at least two sets of slit film weft yarns.

4. A fabric as in claim 3, wherein one of said at least two sets of slit film weft yarns has a slight Z-twist and the other of said at least two sets of slit film weft yarns has a slight S-twist.

5. A fabric as in claim 1, wherein said set of slit film warp yarns and said at least two sets of weft yarns have additives added thereto during a yarn formation process.

6. A fabric as in claim 5, wherein said additive is at least one of a fire retardant, an anti-bacterial, an anti-microbial, or a UV stabilization additive.

7. A fabric as in claim 5, wherein at least one set of said slit film weft yarns includes a metallic color additive.

8. A fabric as in claim 1, wherein said set of slit film warp yarn is colored a different color than said at least two sets of slit film weft yarns.

9. A fabric as in claim 8, wherein each of said at least two sets of slit film weft yarns is colored a different color so that one set of said slit film weft yarns is darker in at least one of shade or color than the other of said at least two sets of slit film weft yarns.

10. A fabric as in claim 9, wherein said set of slit film warp yarns is lighter in at least one of shade or color than said at least two sets of slit film weft yarns.

11. A fabric as in claim 9, wherein said set of slit film warp yarns is darker in at least one of shade or color than said at least two sets of slit film weft yarns.

12. A fabric as in claim 1, wherein at least one of said sets of slit film warp yarns or slit film weft yarns is serrated to form ridges in the woven yarns to create a substantially smooth surface of the fabric that has a texture of dried grass fabric.

13. A fabric as in claim 1, wherein at least one of said sets of slit film warp yarns or slit film weft yarns are delustered.

14. A fabric as in claim 1, wherein said weave is one of a basket weave, a twill, a plain weave, a sateen, a broken twill, or a herring bone.

15. A fabric as in claim 1, wherein at least one of said sets of slit film warp yarns or slit film weft yarns comprises a polypropylene.

16. A fabric as in claim 1, wherein at least one of said sets of slit film warp yarns or slit film weft yarns comprises a polyethylene.

17. A fabric as in claim 16, wherein at least one of said sets of slit film warp yarns or slit film weft yarns comprises a high-density polyethylene.

18. A fabric as in claim 1, wherein said at least two sets of slit film weft yarns alternate in picks in said fabrics.

19. A fabric as in claim 1, wherein said at least two sets of slit film weft yarns are woven with said set of slit film warp yarns so that one of each of said at least two sets of slit film weft yarns is inserted for each shed formation.

20. A fabric as in claim 1, wherein a backing is applied to the fabric to create a wallcovering.

21. A fabric made from yarns that, when woven, mimic dried grass, said fabric comprising:
a set of polyolefin slit film warp yarns;
at least two sets of polyolefin slit film weft yarns interlocking with said set of slit film warp yarns in the form of a weave; and
at least one of said sets of slit film warp yarns or slit film weft yarns being serrated and said other of said sets of slit film warp yarns or slit film weft yarns being fibrillated to form ridges in the woven yarns that creates a fabric that has a texture of a dried grass fabric having a substantially smooth surface.

22. A fabric as in claim 21, wherein said set of slit film warp yarn is colored a different color than said at least two sets of slit film weft yarns.

23. A fabric as in claim 22, wherein each of said at least two sets of slit film weft yarns being colored a different color so that one set of said slit film weft yarns is darker in at least one of shade or color than said other set of weft yarns.

24. A fabric as in claim 23, wherein said set of slit film warp yarns is darker in at least one of shade or color than said at least two set of slit film weft yarns.

25. A fabric made from yarns that, when woven, mimic dried grass, said fabric comprising:
a set of polyolefin slit film warp yarns;
at least two sets of polyolefin slit film weft yarns interlocking with said set of slit film warp yarns in the form of a weave; and
said sets of slit film warp yarns or said at least two sets of slit film weft yarns are at least one of serrated or fibrillated to form ridges in the woven yarns creating a substantially smooth surface on the fabric; and
said at least two sets of slit film weft yarns woven with said set of slit film warp yarns, so that said fabric has a variability due to varying light reflectivity and exposure of said set of slit film warp yarns and said at least two sets of slit film weft yarns within the fabric that creates an overall appearance that is a manifestation of a dried grass fabric.

26. A fabric as in claim 25, wherein said weft yarns are twisted.

27. A fabric as in claim 26, wherein one of said at least two sets of slit film weft yarns has a slight Z-twist and the other of said sets of slit film weft yarns has a slight S-twist.

28. A fabric as in claim 25, wherein said set of slit film warp yarns and said at least two sets of weft yarns have additives added thereto during a yarn formation process.

29. A fabric as in claim 28, wherein said additive is at least one of a fire retardant, an anti-bacterial, an anti-microbial, or a UV stabilization additive.

30. A fabric as in claim 28, wherein at least one set of slit film weft yarns includes a metallic color additive.

31. A fabric as in claim 25, wherein said set of slit film warp yarn is colored a different color than said at least two sets of slit film weft yarns.

32. A fabric as in claim 31, wherein each of said at least two sets of slit film weft yarns being colored a different color so that one set of said slit film weft yarns is darker in at least one of shade or color than the other of said at least two sets of slit film weft yarns.

33. A fabric as in claim 25, wherein at least one of said sets of slit film warp yarns or slit film weft yarns are delustered.

34. A fabric as in claim 25, wherein said weave is one of a basket weave, a twill, a plain weave, a sateen, a broken twill, or a herring bone.

35. A fabric as in claim 25, wherein at least one of said sets of slit film warp yarns or slit film weft yarns comprises a polypropylene.

36. A fabric as in claim 25, wherein at least one of said sets of slit film warp yarns or slit film weft yarns comprises a polyethylene.

37. A fabric as in claim 36, wherein at least one of said sets of slit film warp yarns or slit film weft yarns comprises a high-density polyethylene.

38. A fabric as in claim 25, wherein said at least two sets of slit film weft yarns alternate in picks in said fabrics.

39. A fabric as in claim 25, wherein said at least two sets of slit film weft yarns are woven with said set of slit film warp yarns with one of each of said at least two sets of slit film weft yarns is inserted for each shed formation.

40. A fabric as in claim 25, wherein a backing is applied to the fabric to create a wallcovering.

41. A fabric made from yarns that, when woven, mimic dried grass, said fabric comprising:
a set of polyolefin slit film warp yarns, said set of slit film warp yarns being colored one color;
at least two sets of polyolefin slit film weft yarns interlocking with said warp yarns in the form of a weave, each of said at least two sets of slit film weft yarns being colored a different color so that one of said sets of said slit film weft yarns is darker in at least one of shade or color than the other of said at least two sets of weft yarns;
at least one of said sets of slit film warp yarns or said slit film weft yarns are at least one of serrated or fibrillated to form ridges in the woven yarns creating a substantially smooth appearance on the fabric; and
said at least two sets of slit film weft yarns woven with said set of slit film warp yarns, so that said fabric has a variability due to varying light reflectivity, coloring and exposure of said set of slit film warp yarns and said at least two sets of slit film weft yarns within the fabric that creates an overall appearance that is a manifestation of a dried grass fabric.

42. A fabric as in claim 41, wherein said weft yarns are twisted.

43. A fabric as in claim 42, wherein one of said at least two sets of slit film weft yarns has a slight Z-twist and the other of said at least two sets of slit film weft yarns has a slight S-twist.

44. A fabric as in claim 41, wherein at least one set of slit film weft yarns includes a metallic color.

45. A fabric as in claim 41, wherein at least one of said sets of slit film warp yarns or slit film weft yarns are delustered.

46. A fabric as in claim 41, wherein said weave is one of a basket weave, a twill, a plain weave, a sateen, a broken twill, or a herring bone.

47. A fabric as in claim 41, wherein at least one of said sets of slit film warp yarns or slit film weft yarns comprises a polypropylene.

48. A fabric as in claim 41, wherein at least one of said sets of slit film warp yarns or slit film weft yarns comprises a polyethylene.

49. A fabric as in claim 48, wherein at least one of said sets of slit film warp yarns or slit film weft yarns comprises a high-density polyethylene.

50. A fabric as in claim 41, wherein said color of said set of slit film warp yarns is a different color than the colors of said at least two sets of slit film weft yarns.

51. A fabric as in claim 41, wherein said two sets of slit film weft yarns alternate in picks in said fabrics.

52. A fabric as in claim 51, wherein said at least two sets of slit film weft yarns are woven with said set of slit film warp yarns so that one of each of said at least two sets of slit film weft yarns is inserted into each shed formation.

53. A fabric as in claim 41, wherein a backing is applied to the fabric to create a wallcovering.

54. A fabric comprising:
a set of polyolefin slit film warp yarns;
at least one set of polyolefin slit film weft yarns and at least one set of a second weft yarn interlocking with said warp yarns in the form of a weave;
at least one of said set of polyolefin slit film warp yarns or said set of polyolefin slit film weft yarns are at least one of serrated or fibrillated to form ridges in the woven yarns creating a fabric that has a texture of a dried grass fabric with a substantially smooth appearance; and
said set of polyolefin slit film warp yarns, said set of polyolefin slit film weft yarns and said set of second weft yarns creating a variability and texture in said fabric so that said fabric has a general appearance of a dried grass fabric having a second yarn woven therein.

55. A fabric as in claim 54, wherein said at least one set of second weft yarns comprises BCF yarns.

56. A fabric as in claim 54, wherein said at least one set of second weft yarns comprises a chenille yarns.

57. A fabric as in claim 54, wherein said variability is at least partially attributable to varying light refraction due to processing of said set of polyolefin slit film weft yarns and said set of polyolefin slit film warp yarns.

58. A fabric as in claim 54, wherein said variability is at least partially attributable to different colors of said set of polyolefin slit film weft yarns and said set of polyolefin slit film warp yarns.

59. A fabric as in claim 54, wherein a backing is applied to the fabric to create a wallcovering.

60. A fabric made from yarns that, when woven, mimic dried grass, said fabric comprising:
a set of polyolefin slit film warp yarns;
at least two sets of polyolefin slit film weft yarns interlocking with said set of slit film warp yarns in the form of a weave;
wherein one of said at least two sets of slit film weft yarns has a different orientation of twist relevant to the other of said at least two sets of slit film weft yarns; and
at least one of said sets of slit film warp yarns or slit film weft yarns being fibrillated to form ridges in the woven yarns that creates a fabric that has the texture of a dried grass fabric with a substantially smooth face.

61. A wallcovering having an appearance on its face of a dried grass fabric, said wallcovering comprising:
a fabric having a front and a back, said fabric including:
(a) a set of polyolefin slit film warp yarns;
(b) at least two sets of polyolefin slit film weft yarns interlocking with said set of slit film warp yarns in the form of a weave; and
(c) at least one of said sets of slit film warp yarns or slit film weft yarns being fibrillated to form ridges in the woven yarns that creates a substantially smooth face on the fabric that has the texture of a dried grass fabric; and
a backing disposed on said back of said fabric, said backing adding integrity to said fabric so said fabric is attachable to a surface.

62. A wallcovering as in claim 61, wherein said backing is an acrylic material applied to said fabric.

63. A wallcovering as in claim 61, wherein said backing is a nonwoven laminated to said fabric.

64. A wallcovering as in claim 61, wherein said set of slit film warp yarns is colored a different color than said at least two sets of slit film weft yarns.

65. A wallcovering as in claim 64, wherein each of said at least two sets of slit film weft yarns being colored a different color so that one set of said slit film weft yarns is darker in at least one of shade or color than the other of said at least two sets of slit film weft yarns.

66. A fabric as in claim 61, wherein at least one of said set of slit film warp yarns or slit film weft yarns is serrated to form ridges in the woven yarns that creates a fabric that has a texture of dried grass fabric with a substantially smooth surface.

67. A wallcovering as in claim 61, wherein at least one of said sets of slit film warp yarns or slit film weft yarns are delustered.

68. A wallcovering as in claim 61, wherein said weave is one of a basket weave, a twill, a plain weave, a sateen, a broken twill, or a herring bone.

69. A wallcovering as in claim 61, wherein at least one of said sets of slit film warp yarns or slit film weft yarns comprises a polypropylene.

70. A wallcovering as in claim 61, wherein at least one of said sets of slit film warp yarns or slit film weft yarns comprises a polyethylene.

71. A wallcovering as in claim 61, wherein at least one of said sets of slit film warp yarns or slit film weft yarns comprises a high-density polyethylene.

72. A fabric made from yarns that, when woven, mimic dried grass, said fabric comprising:
a set of polyolefin slit film warp yarns;
a set of polyolefin slit film weft yarns interlocking with said set of slit film warp yarns in the form of a weave; and
at least one of said sets of slit film warp yarns or slit film weft yarns being fibrillated to form ridges in the woven yarns that create a fabric that has a texture of a dried grass fabric having a substantially smooth face.

73. A fabric as in claim 72, wherein at least one of said sets of slit film warp yarns or slit film weft yarns is serrated to form ridges in the woven yarns to create a substantially smooth surface of the fabric that has a texture of dried grass fabric.
